(19) United States
(12) Patent Application Publication
(10) Pub. No.: US 2021/0088835 A1
(43) Pub. Date: Mar. 25, 2021

(54) DISPLAY PANEL, COLOR FILM SUBSTRATE AND MANUFACTURING METHOD THEREOF

(71) Applicants: Hefei BOE Display Technology Co., Ltd., Hefei (CN); BOE TECHNOLOGY GROUP CO., LTD., Beijing (CN)

(72) Inventors: Hailong WEN, Beijing (CN); Tao ZHU, Beijing (CN); Tao YANG, Beijing (CN); Lixing ZHAO, Beijing (CN); Shengguang WANG, Beijing (CN); Shuang LIU, Beijing (CN); Xiaoxiao FAN, Beijing (CN)

(21) Appl. No.: 16/819,340

(22) Filed: Mar. 16, 2020

(30) Foreign Application Priority Data
Sep. 20, 2019 (CN) 201910893819.8

(51) Int. Cl. G02F 1/1335; G02F 1/1339

(52) U.S. Cl. CPC G02F 1/133516; G02F 1/13394; G02F 1/133512

(57) ABSTRACT

The present disclosure relates to a display panel, a color film substrate, and a manufacturing method thereof, and relates to the field of display technology. The color film substrate includes a substrate, a light-shielding layer, a filter layer, a transparent flat layer, and a spacer layer. The filter layer covers first areas of the light-shielding layer. The transparent flat layer has a flat area and a recessed area, where the flat area covers the filter layer and the recessed area covers second area of the light-shielding layer. The spacer layer includes a first spacer in the flat area and a second spacer in the recessed area, and a thickness of the first spacer and a thickness of the second spacer are the same.

### CROSS-REFERENCE TO RELATED APPLICATION

This application claims priority to Chinese Patent Application No. 201910893819.8, filed on Sep. 20, 2019, the contents of which are incorporated by reference in the entirety.

### TECHNICAL FIELD

The present disclosure relates to the field of display technology and, in particular, to a display panel, a color film substrate, and a method for manufacturing a color film substrate.

### BACKGROUND

The liquid crystal display panel is a widely used type of display panel. The liquid crystal display panel generally includes an array substrate and a color film substrate that are assembled. The color film substrate has a spacer made of a negative photoresist material that abuts the array substrate to maintain the cell thickness. In color film substrates, the spacer generally includes a main spacer and a sub-spacer having a height difference (step difference). When manufacturing a color film substrate, a half-tone mask process may be used to form the main spacer and the sub-spacer.

It should be noted that the information disclosed in the Background section above is only used to enhance the understanding of the background of the present disclosure and therefore, may include information that does not constitute the prior art known to those of ordinary skill in the art.

### SUMMARY

The present disclosure provides a display panel, a color film substrate, and a method for manufacturing a color film substrate.

According to an aspect of the present disclosure, a color film substrate is provided, including:

a substrate;

a light-shielding layer disposed on one side of the substrate, and having a plurality of first areas and a plurality of second areas arranged separately, wherein both the first areas and the second areas are disposed with light-transmitting holes, and the light-transmitting holes are arrayed along a row direction and a column direction;

a filter layer covering each of the first areas and filling the light-transmitting holes of each of the first areas;

a transparent flat layer having a flat area and a recessed area, wherein the flat area covers the filter layer, and the recessed area covers the second area and fills the light-transmitting holes of the second areas;

a spacer layer disposed on a surface of the transparent flat layer away from the substrate, and including a first spacer in the flat area and a second spacer in the recessed area, wherein the first spacer and the second spacer have a same thickness, and an orthographic projection of the first spacer and the second spacer on the light-shielding layer and an orthographic projection of the light-transmitting holes on the light-shielding layer do not intersect.

In an exemplary embodiment of the present disclosure, the first areas and the second areas are alternately distributed along the row direction, and any of the second areas includes multiple second spacers that are alternately distributed along the column direction with a column of the light-transmitting holes in the second areas.

In an exemplary embodiment of the present disclosure, any of the first areas includes multiple first spacers that are alternately distributed along the column direction with a column of the light-transmitting holes in the first areas.

In an exemplary embodiment of the present disclosure, the filter layer includes a plurality of filter areas of different colors distributed along the row direction, and each of the filter areas covers a column of the light-transmitting holes.

In an exemplary embodiment of the present disclosure, a thickness of the flat area and a thickness of the recessed area are the same.

In an exemplary embodiment of the present disclosure, a distance between a surface of the flat area away from the substrate and the substrate, and a surface of the recessed area away from the substrate and the substrate is 0.4 μm to 0.6 μm.

According to an aspect of the present disclosure, a manufacturing method for a color film substrate is provided, including:

forming a light-shielding layer having a plurality of first areas and a plurality of second areas on one side of a substrate, where both the first areas and the second areas are disposed with light-transmitting holes, and the light-transmitting holes are arrayed along a row direction and a column direction;

forming a filter layer covering the first areas and filling the light-transmitting holes of the first areas;

forming a transparent flat layer having a flat area and a recessed area, where the flat area covers the filter layer, and the recessed area covers the second area and fills the light-transmitting holes of the second areas;

forming a spacer layer on a surface of the transparent flat layer away from the substrate through one patterning process, the spacer layer including a first spacer in the flat area and a second spacer in the recessed area, where the first spacer and the second spacer have a same thickness, and an orthographic projection of the first spacer and the second spacer on the light-shielding layer and an orthographic projection of the light-transmitting holes on the light-shielding layer do not intersect.

In an exemplary embodiment of the present disclosure, the forming the spacer layer on the surface of the transparent flat layer away from the substrate through one patterning process includes:

forming the spacer layer on the surface of the transparent flat layer away from the substrate by using a full-tone mask through one mask process.

In an exemplary embodiment of the present disclosure, a distance between a surface of the flat area away from the substrate and the substrate, and a surface of the recessed area away from the substrate and the substrate is 0.4 μm to 0.6 μm.

In an exemplary embodiment of the present disclosure, the forming of the spacer layer on the surface of the transparent flat layer away from the substrate through one patterning process, includes:

forming the spacer layer on the surface of the transparent flat layer away from the substrate by using a half-tone mask through one mask process, the half-tone mask including a light-shielding area, a light-transmitting area, and a semi-light-transmitting area, where the light-transmitting area or the light-shielding area is used to form the first spacer, and the semi-light-transmitting area is used to form the second spacer.

In an exemplary embodiment of the present disclosure, a transmittance of the semi-light-transmitting area is not less than 40%.

According to an aspect of the present disclosure, a display panel is provided, including:

the color film substrate according to any one of the above-referenced embodiments;

an array substrate assembled on a side of a spacer layer away from the substrate, where a surface of the first spacer layer away from the substrate abuts against the array substrate.

It should be understood that the above general description and the following detailed description are merely exemplary and explanatory, and should not limit the present disclosure.

### BRIEF DESCRIPTION OF THE DRAWINGS

The drawings herein are incorporated in and constitute a part of this specification, illustrate embodiments consistent with the present disclosure, and together with the description serve to explain the principles of the present disclosure. Understandably, the drawings in the following description are just some embodiments of the present disclosure. For those of ordinary skill in the art, other drawings can be obtained based on these drawings without creative effort.

FIG. 1 is a schematic diagram of an embodiment of a color film substrate according to the present disclosure.

FIG. 2 is a schematic diagram of a spacer layer, a light-shielding layer, and a filter layer in an embodiment of a color film substrate according to the present disclosure.

FIG. 3 is a flowchart of an embodiment of a manufacturing method for a color film substrate according to the present disclosure.

FIG. 4 is a schematic diagram corresponding to step S110 of the manufacturing method of the present disclosure.

FIG. 5 is a schematic diagram corresponding to step S120 of the manufacturing method of the present disclosure.

FIG. 6 is a schematic diagram corresponding to step S130 of the manufacturing method of the present disclosure.

### DETAILED DESCRIPTION

Example embodiments will now be described more fully with reference to the accompanying drawings. However, the example embodiments can be implemented in various forms and should not be construed as limited to the embodiments set forth herein. Rather, these embodiments are provided so that this disclosure will be thorough and complete, and will fully convey the concept of the example embodiments to those skilled in the art. The same reference numerals in the drawings denote the same or similar structures, and thus their detailed descriptions will be omitted. In addition, the drawings are merely schematic illustrations of the present disclosure and are not necessarily drawn to scale.

Although relative terms are used in this specification, such as “up” and “down”, to describe the relative relationship between one component of another icon and another component, these terms are used in this specification only for convenience, for example, according to direction of the examples described. It can be understood that if the device of the icon is turned upside down, the component described above will become the component below. When a structure is “on” another structure, it may mean that a structure is integrally formed on another structure, or that a structure is “directly” disposed on another structure, or that a structure is “indirectly” disposed on other structures.

The terms “a”, “an”, “the”, “said”, and “at least one” are used to indicate the presence of one or more elements, components, etc. The terms “including” and “having” are used to indicate open-ended inclusion and mean that there may be additional elements, components, etc. in addition to the listed elements, components, etc. The terms “first” and “second” are used only as labels or markers, not as a limitation on the number of objects.

An embodiment of the present disclosure provides a color film substrate that can be used in a liquid crystal display panel. The color film substrate may include a plurality of pixels, where each of the pixels includes a plurality of sub-pixels, and the sub-pixel of each of the pixels includes a plurality of colored sub-pixels with different colors and at least one white sub-pixel.

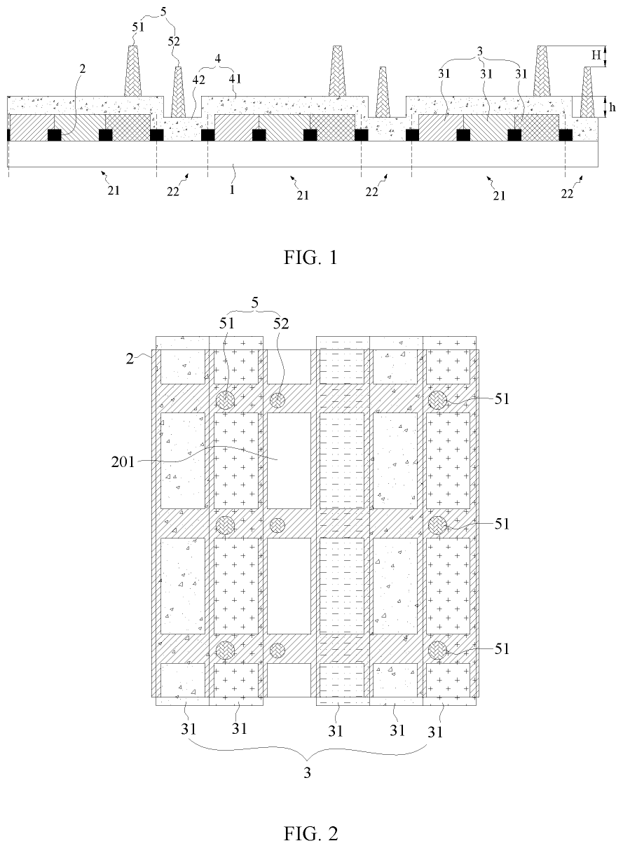

As shown in FIG. 1 and FIG. 2, the color film substrate according to the embodiment of the present disclosure includes a substrate 1, a light-shielding layer 2, a filter layer 3, a transparent flat layer 4, and a spacer layer 5.

The light-shielding layer 2 is disposed on one side of the substrate 1 and has a plurality of first areas 21 and a plurality of second areas 22 disposed separately. Both the first area 21 and the second areas 22 are disposed with light-transmitting holes 201, and the light-transmitting holes 201 are distributed in an array along a row direction and a column direction.

The filter layer 3 covers the first areas 21 and fills the light-transmitting holes 201 of the first areas 21. The transparent flat layer 4 has a flat area 41 and a recessed area 42. The flat area 41 covers the filter layer 3, and the recessed area 42 covers the second areas 22 and fills the light-transmitting holes 201 of the second area 22.

The spacer layer 5 is disposed on a surface of the transparent flat layer 4 away from the substrate 1, and includes a first spacer 51 in the flat area 41 and a second spacer 52 in the recessed area 42. A thickness of the first spacer 51 is the same as a thickness of the second spacer 52, and an orthographic projection thereof on the light-shielding layer 2 is located outside the light-transmitting holes 201. That is, an orthographic projection of the first spacer 51 and the second spacer 52 on the light-shielding layer 2 and an orthographic projection of the light-transmitting holes 201 on the light-shielding layer 2 do not intersect.

In the color film substrate according to the embodiment of the present disclosure, the height difference between the flat area 41 and the recessed area 42 can be used to form the height difference between the first spacer 51 and the second spacer 52, so that the half-tone mask with high transmittance or even a full-tone mask can be used to form the spacer layer 5 at one time, and the height uniformity of the second spacer 52 is improved, thereby improving product yield. Meanwhile, a portion of the filter layer 3 that fills the light-transmitting holes 201 in the first area 21 can be used as a monochrome sub-pixel, and a portion of the transparent flat layer 4 that fills the light-transmitting holes 201 in the second area 22 can serve as a white sub-pixel, that is, transparent sub-pixels, to form an RGBW pixel structure.

It should be noted that the row direction and the column direction in this disclosure only indicate two different directions that intersect. Although the current perspectives in the drawings are horizontal and vertical, respectively, it does not represent that in an actual product; the direction must be horizontal and the column direction must be vertical in various specifications.

Each part of the color film substrate according to the embodiment of the present disclosure is described in detail below:

As shown in FIG. 1, the substrate 1 is a flat plate structure, and its material is a transparent material such as glass or PET (polyethylene terephthalate), which is not particularly limited herein.

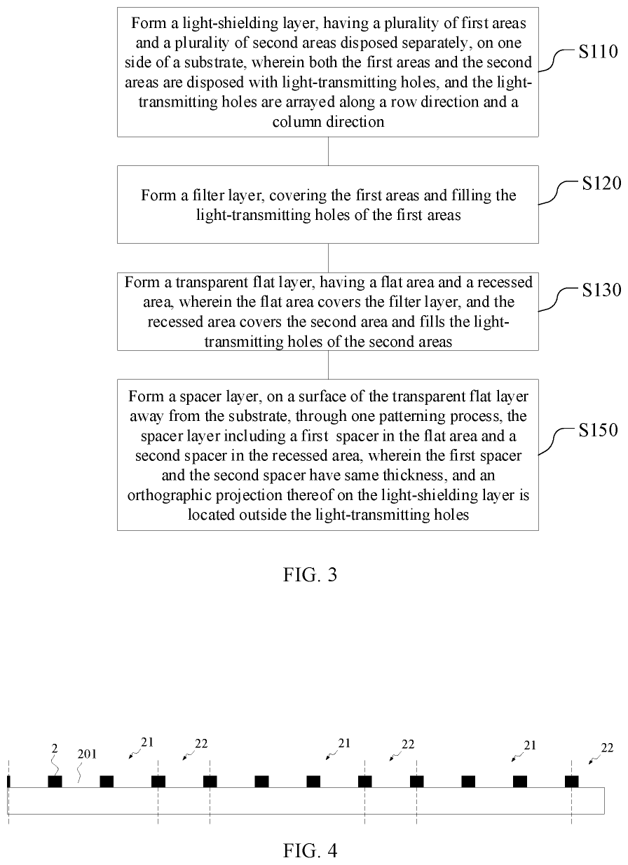

As shown in FIG. 1, FIG. 2, and FIG. 4, the light-shielding layer 2 is disposed on one side of the substrate 1. The light-shielding layer 2 may be a light-shielding material, such as a light-shielding metal, a black resin, and the like. The light-shielding layer 2 may have a plurality of first areas 21 and a plurality of second areas 22 arranged separately. Meanwhile, the light-shielding layer 2 is disposed with a plurality of light-transmitting holes 201 arranged in an array along the row direction and the column direction. The light-transmitting holes 201 are distributed in each of the first areas 21 and the second areas 22. For example, the first areas 21 and the second areas 22 may be alternately distributed along the row direction. Each of the first areas 21 is disposed with a plurality of columns of light-transmitting holes 201, and each of the second areas 22 is disposed with a column of light-transmitting holes 201.

As shown in FIGS. 1, 2, and 5, the filter layer 3 covers the first areas 21 of the light-shielding layer 2 and fills the light-transmitting holes 201 of the first areas 21 to form a monochrome sub-pixel in each of the light-transmitting holes 201 of the first areas 21. Further, the area of the filter layer 3 corresponding to each of the first areas 21 may include a plurality of filter areas 31 of different colors distributed along the row direction, and each of the filter areas 31 covers a column of light-transmitting holes 201 in the first area 21, and the same filter area 31 covers only one column of light-transmitting holes 201.

In an embodiment, as shown in FIG. 1, there are three colors of the filter area 31, such as red (R), green (G), and blue (B), and a set of three filter areas 31 with different colors is periodically distributed.

As shown in FIGS. 1 and 6, the transparent flat layer 4 may cover the filter layer 3 and the second areas 22 of the light-shielding layer 2, and the transparent flat layer 4 has a flat area 41 and a recessed area 42, where the surface of the recessed area 42 away from the substrate 1 is located between the surface of the flat area 41 away from the substrate 1 and the substrate 1. The flat area 41 covers the filter layer 3. The recessed area 42 covers the second areas 22 and fills the light-transmitting holes 201 of the second areas 22 to form white sub-pixels W, that is, transparent sub-pixels, in the light-transmitting holes 201 of the second area 22, so that they can form a RGBW pixel structure, including red R sub-pixels, green G sub-pixels, and blue B sub-pixels and the aforementioned W sub-pixels, with the monochrome sub-pixels formed in the light-transmitting holes 201 of the first areas 21.

The transparent flat layer 4 can be made of a transparent material such as photoresist. The thickness of the flat area 41 is the same as the thickness of the recessed area 42 and can be formed by one patterning process. It may be different, so that the flat area 41 and the recessed area 42 may be formed independently.

The height of the flat area 41 from the substrate 1 is the distance between the surface of the flat area 41 (away from the substrate 1) and the substrate 1, and the height of the recessed area 42 from the substrate 1 is the surface of the recessed area 42 (away from the substrate 1) and the substrate 1. The distance between the two heights is the height difference h between the flat area 41 and the recessed area 42 from the substrate 1. The height difference h between the flat area 41 and the recessed area 42 from the substrate 1 may be 0.4 μm to 0.6 μm, and, of course, may also be greater than 0.6 μm, or less than 0.4 μm.

As shown in FIGS. 1 and 2, the spacer layer 5 may be a negative photoresist material, and may be disposed on a surface of the transparent flat layer 4 away from the substrate 1. The spacer layer 5 may include a first spacer 51 and a second spacer 52. The first spacer 51 and the second spacer 52 are columnar structures, and the cross section may be circular or rectangular. An orthographic projection of the first spacer 51 and the second spacer 52 on the light-shielding layer 2 is located outside the light-transmitting holes 201 to avoid blocking the sub-pixels, and the orthographic projection of the first spacer 51 on the light shielding layer 2 is greater than an orthographic projection of the second spacer 52 on the light shielding layer 2.

The first spacer 51 is located in the flat area 41, and the second spacer 52 is located in the recessed area 42. The thickness of the first spacer 51 and the second spacer 52 is the same. Since the flat area 41 and the recessed area 42 have a height difference h from the substrate 1, the height difference h can be used to make the first spacer 51 and the second spacer 52 have a height difference H from the substrate 1, that is, the distance between the surface of the first spacer 51 (away from the substrate 1) and the substrate 1 is greater than the distance between the surface of the second spacer 52 (away from the substrate 1) and the substrate 1.

After the color film substrate and an array substrate of the present disclosure are assembled, the first spacer 51 abuts the array substrate and plays a main supporting role, while only when being exposed to external force, the second spacer 52 is in contact with the array substrate to play an auxiliary supporting role, thereby preventing the first spacer 51 from being compressed due to excessive compression.

In an embodiment, as shown in FIG. 2, the number of the first spacers 51 in each of the first areas 21 is plural and, in each of the first areas 21, each of the first spacers 51 and a column of transparent holes 201 in the first areas 21 are alternately distributed along the above-mentioned column direction. Of course, the first spacer 51 in the first areas 21 may also have other distribution methods, and the number of the first spacers 51 in the first area 21 may be different.

In an embodiment, as shown in FIG. 2, the number of the second spacers 52 in each of the second areas 22 is plural, and in each of the second areas 22, each of the second spacers 52 and a column of transparent holes 201 in the second areas 21 are alternately distributed along the above-mentioned column direction. Of course, the second spacer 52 in the second areas 22 may also adopt other distribution methods, and the number of the second spacers 52 in the second areas 21 may be different.

An embodiment of the present disclosure provides a manufacturing method for a color film substrate. The color film substrate may be the color film substrate of the foregoing embodiment, and its structure is not described in detail again. As shown in FIG. 3, the manufacturing method includes steps S110-S140.

In Step S110, a light-shielding layer, having a plurality of first areas and a plurality of second areas disposed separately, is formed on one side of a substrate, where both the first areas and the second areas are disposed with light-transmitting holes, and the light-transmitting holes are arrayed along a row direction and a column direction.

In Step S120, a filter layer covering the first areas and filling the light-transmitting holes of the first areas is formed.

In Step 130, a transparent flat layer having a flat area and a recessed area is formed, where the flat area covers the filter layer, and the recessed area covers the second area and fills the light-transmitting holes of the second areas.

In Step 140, a spacer layer is formed on a surface of the transparent flat layer away from the substrate, through one patterning process, where the spacer layer includes a first spacer in the flat area and a second spacer in the recessed area, the first spacer and the second spacer having a same thickness, and an orthographic projection thereof on the light-shielding layer being located outside the light-transmitting holes.

As shown in FIG. 1, in the manufacturing method of the embodiment of the present disclosure, the height difference between the flat area 41 and the recessed area 42 can be used to form a height difference between the first spacer 51 and the second spacer 52, which avoids relying solely on half-tone masks to form this height difference so that the half-tone mask with high transmittance or even a full-tone mask can be used to form the spacer layer 5 at one time, and the height uniformity of the second spacer 52 is improved, thereby improving the product yield. Meanwhile, a portion of the filter layer 3 that fills the light-transmitting holes 201 in the first area 21 can be used as a monochrome sub-pixel, and a portion of the transparent flat layer 4 that fills the light-transmitting holes 201 in the second area 22 can serve as a white sub-pixel, that is, transparent sub-pixels, to form an RGBW pixel structure.

Each step of the manufacturing method according to the embodiment of the present disclosure is described in detail below:

In step S110, as shown in FIG. 4, the light-shielding layer 2 may be a light-shielding material, such as black resin, and the structure thereof may refer to the structure of the light-shielding layer 2 above, which is not described in detail here. The light-shielding layer 2 can be formed through processes such as coating, exposure, development, and cleaning, and the details of each process are not particularly limited herein.

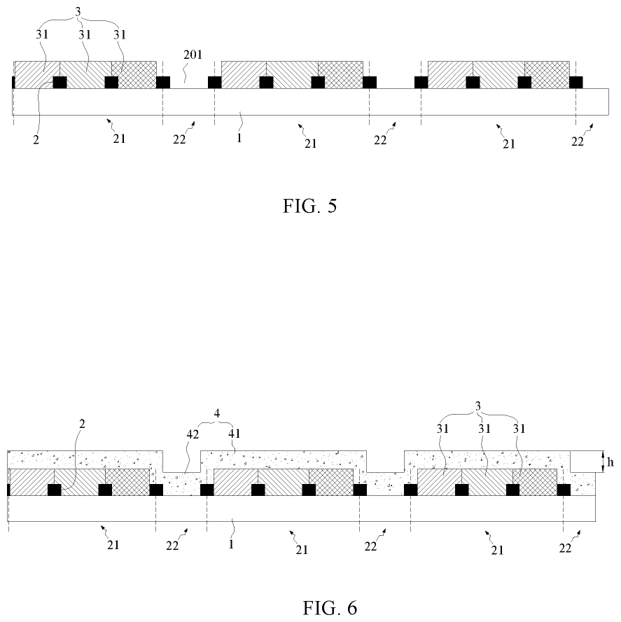

In step S120, as shown in FIG. 5, the filter layer 3 covers the first areas 21 and fills the light-transmitting holes 201 of the first areas 21 to form a monochrome sub-pixel. In an embodiment, an area of the filter layer 3 corresponding to each of the first areas 21 may include a plurality of filter areas 31 of different colors distributed along the row direction, and each of the filter areas 31 covers a column of light-transmitting holes 201 in the first areas 21, and the same filter area 31 covers only one column of light-transmitting holes 201. The filter areas 31 corresponding to the same color can be formed by one patterning process, and the patterning process can include various steps, such as coating, exposure, and development, that is, the filter layer 3 can be formed by multiple patterning processes.

In step S130, as shown in FIG. 6, the material of the transparent flat layer 4 may be a photoresist, and its type is a positive photoresist or a negative photoresist, which is not particularly limited herein. The transparent flat layer 4 may be formed through one patterning process. The flat area 41 of the transparent flat layer 4 covers the filter layer 3, and the recessed area 42 directly covers the second areas 22 of the light-shielding layer 2, such that the height difference between the flat area 41 and the recessed area 42 can be made under the same thickness. Meanwhile, the recessed area 42 fills the light-transmitting holes 201 of the second areas 22, and the portion of the recessed area 42 located in the light-transmitting holes 201 of the second areas 22 can be used as transparent sub-pixels, that is, W sub-pixels, in order to form an RGBW pixel structure, which includes red R sub-pixels, green G sub-pixels, blue B sub-pixels, and the aforementioned W sub-pixels, with the light-transmitting holes 201 of the first areas 21.

In step S140, as shown in FIG. 1, the material of the spacer layer 5 may be a photoresist or other photoresist. The first spacer 51 and the second spacer 52 are formed through one patterning process. The first spacer 51 are formed on the flat area 41, and the second spacer 52 are formed on the recessed area 42. Due to the height difference between the flat area 41 and the recessed area 42 of the transparent flat layer 4, the first spacer 51 and the second spacer 52 also have a height difference.

In an embodiment, the height difference H between the first spacer 51 and the second spacer 52 may be the same as the height difference h between the flat area 41 and the recessed area 42. Step S140 may include:

A full-tone mask is used to form a spacer layer on the surface of the transparent flat layer away from the substrate 1 by using a mask process. The structure of the spacer layer has been described above, and is not repeated here.

In this embodiment, as shown in FIG. 1, since the use of a half-tone mask can be avoided, the non-uniform transmittance of the semi-light-transmitting area of the half-tone mask can be avoided, and the problem of lower uniformity of the second spacer 52 is improved, which improves product yield. In addition, taking a product A having a transparent flat layer 4 as an example, other structures of the product A are not particularly limited herein. The transparent flat layer 4 may be formed by coating a photoresist. The relationship between the amount of coating, the thickness of coating and the height difference is shown in the following table:

| | | | Height difference between | Height difference between |
|---|---|---|---|---|
| | Amount of | Thickness | the flat area and the | the flat area and the |
| | coating | of coating | recessed area corresponding | recessed area corresponding |
| Product | (μL/s) | (μm) | to G sub-pixels (μm) | to B sub-pixels (μm) |
| A | 20000 | 2.0 | 0.59 | 0.62 |
| | 25000 | 2.5 | 0.45 | 0.48 |
| | 30000 | 3.0 | 0.39 | 0.41 |

It can be seen that, for the transparent flat layer 4 with a thickness of 2 μm and a photoresist material, when the transparent flat layer 4 is formed, the amount of coating can be controlled between 20000 μL/s and 3000 μL/s to make the height difference h between the flat areas 41 and of the recessed area 42 is 0.4 μm to 0.6 μm. In this case, for the height difference H of 0.4 μm to 0.6 μm between the first spacer 51 and the second spacer 52, a full-tone mask can be directly used for one-time formation.

In another embodiment, the height difference H between the first spacer 51 and the second spacer 52 may also be greater than the height difference h between the flat area 41 and the recessed area 42. Step S140 may include:

forming the spacer layer on the surface of the transparent flat layer away from the substrate by using a half-tone mask through a mask process. The half-tone mask includes a light-shielding area, a light-transmitting area, and a semi-light-transmitting area. The light-transmitting area or the light-shielding area is used to form the first spacer, depending on the material of the spacer layer. The semi-light-transmitting area is used to form the second spacer.

In this embodiment, since the flat area 41 and the recessed area 42 have made the first spacer 51 and the second spacer 52 have a certain height difference, the height difference formed by using the half-tone mask can be reduced. Therefore, a half-tone mask with high transmittance can be used, which is beneficial to improve the uniformity of the transmittance, and further improve the uniformity of the second spacer 52. In addition, through experiments, the applicant found that, as shown in the following table, the smaller the height difference between a highest second spacer 5 and a lowest second spacer 52, the better the uniformity of the second spacer 52, and the smaller the 3σ, the higher the uniformity of the second spacer 52. It can be seen that the transmittance of the half-tone mask is positively related to the uniformity of the height of the second spacer 52.

| Transmittance of | | | | 100% |
|---|---|---|---|---|
| half-tone mask | 9% | 12% | 16% | (Full-tone mask) |
| Height difference | 0.39 | 0.30 | 0.25 | 0.17 |
| between a highest | | | | |
| second spacer 5 and | | | | |
| a lowest second | | | | |
| spacer 5 (μm) | | | | |
| Height of the second | 0.20 | 0.16 | 0.14 | 0.09 |
| spacer 3σ (Sigma) | | | | |

Meanwhile, it has been verified that the uniformity of the second spacer 52 is good when the transmittance of the semi-light-transmitting area is not less than 40%.

It should be noted that although the steps of the method in the present disclosure are described in a specific order in the drawings, this does not require or imply that the steps must be performed in the specific order, or all steps shown must be performed to achieve desired results. Additionally or alternatively, certain steps may be omitted, multiple steps may be combined into one step for execution, and/or one step may be split into multiple steps for execution, and so on.

An embodiment of the present disclosure further provides a display panel including a color film substrate and an array substrate, wherein:

the color film substrate is the color film substrate of any of the foregoing embodiments, and its structure is not described herein again.

The array substrate and the color film substrate can be assembled, and located on the side of the spacer layer 3 away from the substrate 1, and the surface of the first spacer 51 away from the substrate 1 abuts the array substrate to maintain the cell thickness.

In the display panel, the color film substrate, and the manufacturing method thereof of the present disclosure, the filter layer covers the first area of the light-shielding layer and does not cover the second area, so that there is a height difference between the flat area covering the filter layer and the recessed area covering the second area. Since the first spacer is located in the flat area and the second spacer is located in the recessed area, the height difference between the flat area and the recessed area can be used to form the height difference between the first spacer and the second spacer, so that the half-tone mask with high transmittance or even a full-tone mask can be used to form the spacer layer at one time, and the height uniformity of the second spacer is improved, thereby improving the product yield.

Meanwhile, a portion of the filter layer filling the light-transmitting holes in the first area can be used as monochrome sub-pixels, and a portion of the transparent flat layer filling the light-transmitting holes in the second area can be used as white sub-pixels, that is, transparent sub-pixels.

The display panel according to the embodiment of the present disclosure can be used in electronic devices such as mobile phones, computers, televisions, and electronic papers. For the beneficial effects, refer to the beneficial effects of the color filter substrates described above, which will not be described in detail here.

Those skilled in the art will readily contemplate other embodiments of the present disclosure after considering the specification and practicing the invention disclosed herein. This application is intended to cover any variations, uses, or adaptations of this disclosure that conform to the general principles of this disclosure and include the common general knowledge or conventional technical means in the technical field not disclosed by this disclosure. It is intended that the specification and examples be considered as exemplary only, with a true scope and spirit of the disclosure being indicated by the following claims.

What is claimed is:

1. A color film substrate, comprising:
a substrate;
a light-shielding layer disposed on one side of the substrate, and having a plurality of first areas and a plurality of second areas arranged separately, wherein light-transmitting holes are formed in both the first areas and the second areas, and the light-transmitting holes are arrayed along a row direction and a column direction;
a filter layer covering each of the first areas and filling the light-transmitting holes of each of the first areas;
a transparent flat layer having a flat area and a recessed area, wherein the flat area is covered on the filter layer, and the recessed area is covered on the second area and fills the light-transmitting holes of the second areas; and
a spacer layer disposed on a surface of the transparent flat layer away from the substrate, and comprising a first spacer in the flat area and a second spacer in the recessed area, wherein the first spacer and the second spacer have a same thickness, and an orthographic projection of the first spacer and the second spacer on the light-shielding layer and an orthographic projection of the light-transmitting holes on the light-shielding layer do not intersect.

2. The color film substrate according to claim 1, wherein the first areas and the second areas are alternately distributed along the row direction, and any of the second areas comprises multiple second spacers that are alternately distributed along the column direction with a column of the light-transmitting holes in the second areas.

3. The color film substrate according to claim 1, wherein any of the first areas comprises multiple first spacers that are alternately distributed along the column direction with a column of the light-transmitting holes in the first areas.

4. The color film substrate according to claim 1, wherein, the filter layer comprises a plurality of filter areas of different colors distributed along the row direction, and each of the filter areas is covered on a column of the light-transmitting holes.

5. The color film substrate according to claim 1, wherein a thickness of the flat area and a thickness of the recessed area are the same.

6. The color film substrate according to claim 1, wherein a distance between a surface of the flat area away from the substrate and the substrate and a surface of the recessed area away from the substrate and the substrate is 0.4 μm to 0.6 μm.

7. A manufacturing method for a color film substrate, comprising:
forming a light-shielding layer having a plurality of first areas and a plurality of second areas on one side of a substrate, wherein light-transmitting holes are formed in both the first areas and the second areas, and the light-transmitting holes are arrayed along a row direction and a column direction;
forming a filter layer covering the first areas and filling the light-transmitting holes of the first areas;
forming a transparent flat layer having a flat area and a recessed area, wherein the flat area covers the filter layer, and the recessed area covers the second area and fills the light-transmitting holes of the second areas; and
forming a spacer layer on a surface of the transparent flat layer away from the substrate through one patterning process, the spacer layer comprising a first spacer in the flat area and a second spacer in the recessed area, wherein the first spacer and the second spacer have a same thickness, and an orthographic projection of the first spacer and the second spacer on the light-shielding layer and an orthographic projection of the light-transmitting holes on the light-shielding layer do not intersect.

8. The manufacturing method according to claim 7, wherein the forming of the spacer layer on the surface of the transparent flat layer away from the substrate through one patterning process, comprises:
forming the spacer layer on the surface of the transparent flat layer away from the substrate by using a full-tone mask through one mask process.

9. The manufacturing method according to claim 8, wherein a distance between a surface of the flat area away from the substrate and the substrate and a surface of the recessed area away from the substrate and the substrate is 0.4 μm to 0.6 μm.

10. The manufacturing method according to claim 7, wherein the forming of the spacer layer on the surface of the transparent flat layer away from the substrate through one patterning process, comprises:
forming the spacer layer on the surface of the transparent flat layer away from the substrate by using a half-tone mask through one mask process, the half-tone mask comprising a light-shielding area, a light-transmitting area, and a semi-light-transmitting area, wherein the light-transmitting area or the light-shielding area is used to form the first spacer, and the semi-light-transmitting area is used to form the second spacer.

11. The manufacturing method according to claim 10, wherein a transmittance of the semi-light-transmitting area is not less than 40%.

12. A display panel, comprising:
a color film substrate, comprising:
a substrate;
a light-shielding layer disposed on one side of the substrate, and having a plurality of first areas and a plurality of second areas arranged separately, wherein light-transmitting holes are formed in both the first areas and the second areas, and the light-transmitting holes are arrayed along a row direction and a column direction;
a filter layer covering each of the first areas and filling the light-transmitting holes of each of the first areas;
a transparent flat layer having a flat area and a recessed area, wherein the flat area is covered on the filter layer, and the recessed area is covered on the second area and fills the light-transmitting holes of the second areas; and
a spacer layer disposed on a surface of the transparent flat layer away from the substrate, and comprising a first spacer in the flat area and a second spacer in the recessed area, wherein the first spacer and the second spacer have a same thickness, and an orthographic projection of the first spacer and the second spacer on the light-shielding layer and an orthographic projection of the light-transmitting holes on the light-shielding layer do not intersect; and
an array substrate assembled on a side of a spacer layer away from the substrate, wherein a surface of the first spacer layer away from the substrate abuts against the array substrate.

13. The display panel according to claim 12, wherein the first areas and the second areas are alternately distributed along the row direction, and any of the second areas comprises multiple second spacers that are alternately distributed along the column direction with a column of the light-transmitting holes in the second areas.

14. The display panel according to claim 12, wherein any of the first areas comprises multiple first spacers that are alternately distributed along the column direction with a column of the light-transmitting holes in the first areas.

15. The display panel according to claim 12, wherein the filter layer comprises a plurality of filter areas of different colors distributed along the row direction, and each of the filter areas is covered on a column of the light-transmitting holes.

16. The display panel according to claim 12, wherein a thickness of the flat area and a thickness of the recessed area are the same.

17. The display panel according to claim 12, wherein a distance between a surface of the flat area away from the substrate and the substrate and a surface of the recessed area away from the substrate and the substrate is 0.4 nm to 0.6 nm.
